(19) United States
(12) Patent Application Publication
(10) Pub. No.: US 2024/0057608 A1
(43) Pub. Date: Feb. 22, 2024

(54) SLOW RELEASE FORMULATIONS OF PHOSPHOROUS ACID AND PHOSPHITE SALTS

(71) Applicant: LUXEMBOURG INDUSTRIES LTD., Tel Aviv-Yafo (IL)

(72) Inventors: Ganit LEVI RUSO, Beer Sheva (IL); Idan SHAMAI, Kibbutz Mishmarot (IL); Ariel EWENSON, Rehovot (IL)

(21) Appl. No.: 18/493,195

(22) Filed: Oct. 24, 2023

Related U.S. Application Data
(63) Continuation-in-part of application No. PCT/IL2022/050419, filed on Apr. 25, 2022.

(30) Foreign Application Priority Data
Apr. 26, 2021 (IL) 282669

(51) Int. Cl. A01N 59/26; A01N 25/10; A01N 25/12; A01P 5/00; A01P 3/00

(52) U.S. Cl. CPC A01N 59/26; A01N 25/10; A01N 25/12; A01P 5/00; A01P 3/00

(57) ABSTRACT

An agrochemical composition comprising:
an absorbent cellulosic carrier with one or more metal compound(s) incorporated into the carrier, and
an active agent selected from the group consisting of phosphorous acid and phosphite salts that contain the monovalent anion [HP(O)(OX)(O⁻)], where X is H or CH₂CH₃.

Phosphorous acid (H₃PO₃ or H₂PHO₃; also named phosphonic acid) forms different series of salts (collectively known as phosphite or phosphonate salts), i.e., monovalent and divalent salts. The structure of the acid is depicted below, showing the nonacidic character of the third hydrogen atom that is attached directly to the phosphorus atom (alongside phosphoric acid (H₃ PO₄), which has three acidic hydrogens):

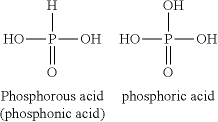

Phosphates (the salts created by phosphoric acid) are valuable fertilizers, supplying phosphorus to the plant. Phosphites, on the other hand, have a direct fungicidal activity (see U.S. Pat. No. 4,075,324), and can serve other function (fungicidal and potentially also nutritional). Owing to their good water solubility, phosphite salts are generally formulated in aqueous solutions delivered, e.g., as foliar sprays or by soil drenching; the salts are absorbed through the plants' roots and leaves.

Liquid formulations of salts of phosphorous acid for agricultural use are described, e.g., in WO2011/065832. Solid formulations, for example, wettable granules of calcium salts of phosphorous acid, can be found US 2011/0105323.

Phosphite-containing formulations described in the above-mentioned publications and commercial products available on the marketplace provide rapid release of the active ingredient. Relatively little has been reported on slow release formulations of phosphites.

US 2013/0210624 illustrates the use of clays like montmorillonite as a carrier, onto which a mixture of phosphate and phosphite is loaded. The resulting granular material is employed as a fertilizer or a fungicide respectively. Unfortunately, no Working Examples are included in US 2013/0210624 to evaluate the efficiency of the clay-based formulations.

Slow-release formulations of salts of phosphorous acid are known also from WO 02/049430, based on a porous carrier that is coated with polysaccharides. A solution of phosphorous acid potassium salt was mixed with a zeolite carrier and some coating-forming additives based on polysaccharides. The polysaccharides are derived from microorganisms; the water-insoluble polysaccharides β-glucan, pestan, and curdlan were illustrated as coating formers. To evaluate the efficiency of the formulation, it was mixed with water, allowed to stand for a while, and then the supernatant was collected to determine the concentration of phosphorous acid. By repeating the procedure several times (to simulate a periodically performed irrigation), a sustained release was shown. As illustrated in the experimental section below, after the fifth cycle, ˜60% of the total amount of the active ingredient was released from the polysaccharide-coated zeolite carrier of WO 02/049430.

By “monovalent phosphite salt” we mean water-soluble salt that contains the monovalent anion [HPO(OX)(O⁻)], where X is H or CH₂CH₃, namely, the anion [HP(O)(OH)(O⁻)], which is hereinafter written (H₂PO₃)⁻, or the organic phosphite anion [HPO(O)(OCH₂CH₃)(O⁻)]. Correspondingly, a monovalent salt is selected from the group consisting of Mⁿ⁺(H₂PO₃), and Mⁿ⁺[HP(O)(OCH₂CH₃)(O⁻)]ₙ, where M is the counter cation. Note that M is not necessarily a monovalent cation.

By “divalent phosphite salt” we mean water-soluble salt that contains the divalent anion [HP(O)(O⁻)O⁻)], which is hereinafter written (HPO₃)²⁻. Correspondingly, preferred divalent salts are selected from the group consisting of M₂HPO₃, where M is a monovalent counter cation.

We have now found that phosphorous acid and monovalent phosphite salts, e.g., monopotassium phosphite (K(H₂PO₃); abbreviated MPP), monoammonium phosphite (NH₄(H₂PO₃); abbreviated MAP) and Fosetyl-Aluminum (Al[HP(O)(OCH₂CH₃)(O⁻)]₃), can be formulated with cellulosic carriers (with a basic metal-containing compound) to provide slow release formulations. In contrast, the divalent salts M₂HPO₃, e.g., dipotassium phosphite (K₂HPO₃; abbreviated DPP) and diammonium phosphite ((NH₄)₂HPO₃; abbreviated DAP) are released more rapidly from these cellulosic carriers. The dissimilar release profiles shown by the free acid/monovalent phosphite salts on the one hand, and the M₂HPO₃ salts, on the other hand, were observed in different experimental models, e.g., 1) filtration experiments (water-soaked cellulosic carrier applied on a filtration paper; amount of the active ingredient was measured in the filtrate produced); 2) simulating irrigation, as described in WO 02/049430, with each irrigation cycle consisting of holding a carrier/water mixture for some time; the amount of the active ingredient was measured in a supernatant collected); and 3) irrigation of soil samples (soil is mixed with the carrier; a metered amount of water is added periodically to create a runoff; the amount of the active ingredient was measured in the runoff).

In the three experimental models, the same trend was noted: the release rate of the free acid and monovalent phosphite salts from the cellulosic carrier was significantly slower compared to the divalent phosphite salts, suggesting that the free acid and MH₂PO₃ salts bind more tightly to the cellulosic carrier, as opposed to a loosely associated M₂HPO₃. A different type of association between a cellulosic carrier and MH₂PO₃/M₂HPO₃ salts is perhaps suggested by FTIR spectroscopy analysis. The FTIR spectrum of diammonium phosphite (DAP)—cellulosic carrier (FIG. 1) shows no shifting in the position of the characteristic peak at 1065 cm⁻¹ (marked by an arrow in FIG. 1). In contrast, the FTIR spectrum of monoammonium phosphite (MAP)—cellulosic carrier (FIG. 2) shows that the 1065 cm⁻¹ peak shifted to 980 cm⁻¹.

Additionally, experimental results reported below indicate that metal-containing compounds possessing basic properties, e.g., carbonates, oxides, or hydroxides of alkaline earth metals or higher valency metals, when incorporated into the cellulosic carrier, influence the release profile of phosphorous acid and monovalent phosphite salts from the carrier. For example, carbonate and oxide of calcium were shown to substantially slow down the release of the acid and monovalent phosphite salts.

Accordingly, the invention is primarily directed to an agrochemical composition comprising:
an absorbent cellulosic carrier with a metal-containing compound incorporated into the carrier, e.g., a basic metal-containing compound, and
an active agent (e.g., exhibiting fungicidal, nematocidal or nutritional function) selected from the group consisting of phosphorous acid and monovalent phosphite salts.

One preferred type of carrier consists of cellulosic granules with good water absorbency (e.g., of not less than 0.05 ml/g, e.g., from 0.05 to 0.7 ml/g; also indicated by nominal liquid holding capacity >10%, e.g., of 15 to 20%), to reach a high loading level of the phosphorous acid or monovalent phosphite salts in the granules (as described below, aqueous solutions of the acid or the salts prepared beforehand, are mixed with the carrier to form the composition of the invention).

The size of the cellulosic granules is in the range of 0.3 to 5 mm, e.g., 0.3 to 2 mm, for example, 0.3 to 0.8 mm or 0.8 to 1.7 mm (corresponding to mesh designation of 4/50, 10/35, 20/50 and 12/20, respectively; the X/Y notation matches US Standard Sieve and indicates that at least 80%, or at least 90% of the particles, passed through the X-mesh sieve and were retained by Y-mesh sieve). The preferred bulk density of the cellulosic granular material is in the range of 0.6 g/cc to 0.9 g/cc.

Suitable cellulosic granular materials can be prepared from paper or pulp sludges by the methods described, for example, in U.S. Pat. Nos. 5,019,564, 5,770,138 and 7,867,947. De-inked paper sludge contains about 90% water; solid content of 40-90% cellulosic fiber and 10-60% inorganic fillers/pigments (chiefly kaolin, calcium carbonate, titanium dioxide and barium sulfate). De-inked paper is dewatered to adjust its moisture content, reaching about 40-50% solids content. The paper sludge is processed to reduce fiber size (in a reduction mill, or a shredder) to arrive at an average fiber length of about 1-10 mm. Suitable additives can be added at this stage, including the abovementioned basic metal compounds, such as calcium carbonate, which, as discussed above, serves a useful purpose in controlling the release profile of the H₃PO₃ and MH₂PO₃ salts from the carrier. The sludge mass is then agglomerated/granulated, optionally with some added water, e.g., in a drum pelletizer or granulator. Next, the granules are fed to a rolling device, such as the one described in U.S. Pat. No. 5,770,138, and the product collected is dried.

Cellulosic granules obtainable from the paper and pulp industries are available in the marketplace; the H₃PO₃ and monovalent phosphite salts can be added to commercial cellulosic granular material, by the methods described below. One type of absorbent cellulosic granules which is well suited for a slow release of H₃PO₃ and monovalent phosphite salts is sold under the trade name Biodac®. For example, we studied the release of phosphorous acid, MH₂PO₃, Al[HP(O)(OCH₂CH₃)(O⁻)]₃ and M₂HPO₃ salts from Biodac® 12/20 and 20/50 grades. Some of the properties of Biodac® 12/20 are presented in Table 1 (data taken from Kadant GranTek Inc.)

TABLE 1
General Properties of Biodac 12/20 US Sieve

| Bulk density | 45.0 ± 3.0 lbs./cft | |
|---|---|---|
| Moisture control | <4.0% | |
| pH | 7.0 to 7.5-Biodac is pH neutral | |
| Resistance to attrition | >99.0% | |
| Liquid holding capacity | 18.00% | |
| Screen analysis | +12 mesh | <1.0% |
| | 12 to 20 mesh | 80.0% minimum |
| | 20 to 30 mesh | 20.0% maximum |
| | −30 mesh | <1.0% |

Absorbent cellulosic granules obtainable from the paper and pulp industries such as Biodac® have an important benefit: metal-containing fillers with basic character, e.g., calcium carbonate, are present in such granular materials. We measured the concentration of trace metals in Biodac® 12/20 granules by inductively coupled plasma atomic emission spectroscopy (EPA 6010 D) and detected ˜150,000-200,000 ppm calcium and ˜25000-35000 ppm aluminum. However, as shown below, slow release of the active ingredient from the cellulosic carriers can be achieved with lesser amounts of alkaline earth metal compounds in the carrier.

Hence, a carrier suitable for use is preferably in the form of absorbent cellulosic granules, with a cellulosic fiber content of not less than 10% (for example, 30% or 50% by weight), which contains one or more mineral fillers, wherein at least one of said mineral fillers is a metal compound, preferably selected from the group consisting of alkaline earth metal compounds and aluminum compounds (e.g., the corresponding carbonate, oxide or hydroxide), present at a total concentration of not less than 1% by weight (for example, 2%, e.g., in the range of 2% to 25%), based on the weight of the carrier (absent the added active ingredient).

One aspect of the invention is a granular agrochemical formulation, comprising a cellulose carrier as described above (e.g., Biodac®), loaded with phosphorous acid or a monovalent phosphite salt, and optionally a divalent salt of phosphorous acid. According to a preferred embodiment of the invention, the monovalent salt is MAP or MPP, and the divalent salt is DAP or DPP.

As an aside, it is known that Biodac® granules are used as carriers of insecticides, biocides, and nutrients. The abovementioned U.S. Pat. No. 7,867,947 provides examples of the application of Biodac® granules as a carrier for fertilizers and agriculturally active compounds, e.g., a method of making a blend of two types of agriculturally beneficial granules: fertilizer-containing granules and Biodac® granules loaded with pesticides.

An absorbent cellulosic carrier for use in the invention is not limited to a granular form, such as Biodac®. Other types of absorbent cellulosic carriers produced by the paper industry can be used. We tested ˜0.5-1.5 mm thick paper strips with a surface texture similar to Whatman® filter papers and found that these cellulosic strips or bands (for example, 3-7 mm wide, 1-5 cm long and ˜0.5-1.5 mm thick pieces) act as good absorbents, taking up appropriate volumes of aqueous solutions of phosphorous acids or phosphite salts, insomuch that they can serve as an agricultural carrier for use in the invention. On addition of a fairly small amount of one or more basic metal compounds, such as calcium carbonate, calcium oxide, magnesium carbonate, magnesium oxide and the like, phosphorous acid or monovalent phosphite salts become tightly bound to the cellulosic fibers of such paper strips and bands. Suitable products have recently entered the marketplace and relevant technologies of recycling paper based on the formation of cellulose nanocrystals with chemical composition akin to that of Whatman® paper have been reported [BioResources 13(4), 7404-7429 (2018)].

Thus, the absorbent cellulosic carrier for use in the invention comprises filter paper, blotting paper, chromatographic paper or cellulose pulp sheets, in various textures (smooth, crepe, rough), with different porosity, particle retention, wet strength, etc. The paper can be made of different paper pulps, e.g., softwood, hardwood, fiber crops, mineral fibers. The paper can be treated with some reagents, for example, to add the basic metal (e.g., alkaline earth metal) compound.

Accordingly, another preferred type of carrier for use in the invention consists of absorbent cellulosic material in the form of shredded paper (filter paper, blotting paper, chromatographic paper, cellulose pulp sheets), to which was added one or more basic metal compounds, at a concentration of not less than 1% by weight (for example, ≥2%, e.g., in the range of 2% to 10%), based on the weight of the carrier (absent the added active ingredient).

The active agent is added to the carrier in the form of an aqueous solution. Aqueous solutions of phosphorous acid and phosphite salts are prepared beforehand, by dissolving the acid, or salts available in solid form, in water. Alternatively, phosphorous acid is reacted with alkali or ammonium hydroxide in water, to form an aqueous solution of the corresponding salt or mixture of salts. The calculated acid concentration in the solution is in the range of 10-50%, preferably 20-40%, more preferably 27-33% (e.g., ˜30%) by weight.

Next, the cellulosic carrier, e.g., the granules, are impregnated with the aqueous solution of the acid or phosphite salts at a mix ratio of 50:1 to 1:1 by weight (carrier to solution), e.g., around 2:1, to achieve 1-30% phosphorous acid loading onto the carrier, e.g., 1-15%. In other words, the solutions are absorbed on the granular carrier to produce granules containing the respective salts in an amount equivalent to 1-15% of the phosphorous acid, preferably 7-12%, e.g., around 9 to 11%. The aqueous solution can be applied on the carrier in different ways, e.g., by thoroughly mixing the carrier, e.g., the granules, with the aqueous solution of the active ingredient (for example, in a drum mixer) or by spraying the solution onto the carrier, to produce granules (or paper strips) that are uniformly loaded with the phosphorous acid or phosphite salts. The wetted granules can be air dried; but usually, the carrier does not require drying, provided that the amount of added aqueous solution does not exceed the liquid holding capacity of the carrier.

As pointed out above, in contrast to the free acid/MH₂PO₃ salts, the M₂HPO₃ are released rather quickly from absorbent cellulosic carriers. Hence, it is possible to adjust the rate of release of the (e.g., fungicidally) active agent from the carrier by selecting suitably proportioned blends consisting of: at least one of H₃PO₃ and MH₂PO₃ salts; and at least one of M₂HPO₃ salts.

For example, mixtures consisting of a slowly released component [H₃ PO₃ or MH₂PO₃] and a more rapidly released component [M₂HPO₃], proportioned 5:1 to 1:5 by weight, e.g., 4:1 to 1:4, can be added to the carrier. Experimental results reported below indicate that it is possible to generate varied release profiles of the active ingredient with the aid of MH₂PO₃: M₂HPO₃ mixtures formulated across the weight ratio range of 3:1 to 1:3, i.e., the release rate slows down with increasing proportion of the MH₂PO₃ salt. The cations of the individual salts used to form the mixture may be the same (e.g., KH₂PO₃+K₂HPO₃; (NH₄)H₂PO₃+(NH₄)₂HPO₃) or different (e.g., (NH₄)H₂PO₃+K₂HPO₃). Coformulations are obtained by preparing separate aqueous solutions of the individual salts, and adding them to the carrier, either simultaneously or successively. Thus, it is possible to control the rate of phosphites that are released from the carrier by mixing MPP and DAP, or MAP and DAP.

The invention further relates to a process for the preparation of a slow release agrochemical composition, comprising impregnating an absorbent cellulosic carrier with an aqueous solution of phosphorous acid or a monovalent phosphite salt, and optionally with an aqueous solution of a divalent salt of phosphorous acid (e.g., to produce granules containing the respective salts in an amount equivalent to 5-15% of the phosphorous acid), and optionally drying to form an absorbent carrier containing a slowly-released active ingredient and optionally a quickly released active ingredient.

Another aspect of the invention is a method of supplying phosphorous acid/phosphite salts to a plant, by adding the composition of the invention to the soil or growth medium, to achieve prolonged release of the active ingredient. The invention relates to a method of supplying phosphorous acid or a monovalent phosphite salt to a plant (in a controllable manner, i.e., by slowly releasing the active ingredient, optionally in admixture with a divalent salt of the acid), for example, to protect a plant against soil noxious organisms (e.g., a fungal disease, a nematode attack or attack by Phytomyxea), or to fertilize the plant, the method comprises applying the formulation described above to the soil or growth medium.

The composition of the invention can be used to control/suppress, e.g., Phytophthora spp., Pythium spp. Bacteria spp., Peronospora spp., and others (Phytomyxea such as Club root and Powder scab and Rhizoctonia spp. and Fusarium spp.) on a variety of fruits and vegetables such as apples, avocados, tomatoes, peppers, cabbage, potatoes, grapevines, ornamental crops, turf, and trees [see further details in PPDB (Pesticide Properties Database created by the University of Hertfordshire https://sitm.herts.ac.uk/aeru/ppdb/en/index.htm)].

The absorbent cellulosic carrier, e.g., the granules, or the paper strips, to which the free acid or the monovalent phosphite salt was added (and optionally M₂HPO₃), are uniformly distributed in the sowing strap or all over the area to be treated, for example, using a drop spreader or a broadcast spreader. After application, an irrigation program is initiated to start delivering metered amounts of water (e.g., by sprinkling), whereby the active ingredient is released to the soil from the water-soaked carrier. Because only a small—yet effective—amount of the phosphite is released from the carrier to be absorbed by the plant per time, the composition of the invention needs to be applied fewer times, for example, when spread over a lawn, compared to quick release formulations, and the plant is provided with a continuous supply of phosphites over an extended time period. Laboratory-scale studies indicate that under periodic addition of constant amounts of water to the carrier (each time 400 ml of water were added to 2 g of the cellulosic carrier; a total number of ten cycles), the cumulative amount of phosphite released increases roughly linearly. For example, following an initial release of ˜20% of the total amount of the active ingredient, the amount of released phosphite increases steadily by about 5 to 10%, each time a constant volume of water is added.

The slow release formulation of the invention can be used to prevent, or inhibit, the development of fungus including downy mildew. When used to protect crops against fungus, application rates vary from, e.g., 0.5 to 10 kg of the active ingredient per hectare.

The composition of the invention can be applied in-furrow or in planting pits, to act solely or in conjunction with organic fungicides. Field trials reported below show that the composition of the invention, when used in combination with organic fungicides, can improve yield and plant vigor of vegetables (e.g., Solanales, Brassicaceae/Cruciferae and Cucurbitales), compared to a conventional treatment consisting of the organic fungicides acting alone. For example, through in-furrow application of the composition of the invention at the time of planting, and subsequent foliar spray of one or more organic fungicides. When the composition of the invention is used in-furrow, the recommended application rate of the granular composition of the invention is about 20 to 250 ounces of the granules per 1,000 row feet, e.g., 0.5 to 20 kg of the granules per 1,000 row meter, e.g., 2.5 to 7 kg per 1000 row meter.

Organic fungicides which can be applied in conjunction with the composition of the invention may be selected from different classes identified chemically or by the internationally acceptable FRAC group code (Fungicide Resistance Action Committee): carbamates, such as Mancozeb; Pyridinylmethyl-benzamides or FRAC Group 43, such as Chlorothalonil and Fluopicolide; benzamides or FRAC group 22, such as Zoxamide; cyanoimidazole or FRAC Group 21, such as Cyazofamid; triazoles or FRAC group 3, such as Difenoconazole; phenyl-oxo-ethyl thiophene amides or FRAC Group 7, such as isofetamid; methoxyacrylates or FRAC Group 11, such as Azoxystrobin; 2,6-dinitroanilines or FRAC Group 29, such as Fluazinam; and mixtures thereof. The organic fungicide(s) can be applied in-furrow at the time of planting or at an appropriate time by foliar spray. When a mixture of organic fungicides is used, the individual organic fungicides may be applied simultaneously, sequentially and also in an alternate manner over a period of time.

For example, in-furrow application of cellulosic granules (e.g., Biodac®) which contain monoammonium or monopotassium phosphite at the time of planting potato, in combination with conventional treatment based on organic fungicides to protect the potato from late blight and/or early blight (e.g., by foliar spray of chlorothalonil, mancozeb and mixtures thereof), was shown to have good effect on the yield and vigor of potato at application rate in the range of 20 to 120 ounces of the granules per 1,000 row feet. Marketable yield was increased by more than 10%, e.g., by 15 to 30%, compared to the conventional treatment (e.g., compared to foliar application of the organic fungicides).

### BRIEF DESCRIPTION OF THE FIGURES

FIG. 1 is a DAP-Biodac® FTIR spectrum.

FIG. 2 is a MAP-Biodac® FTIR spectrum.

FIG. 3 shows a plot of the release rate of the phosphites from Biodac® granules versus time.

FIG. 4 shows a plot of the release rate of the phosphites from Biodac® granules, made by the test method of WO 02/049430, in comparison with the results presented in WO 02/049430.

FIG. 5 shows a plot of the release rate of MAP and DAP from Biodac® granules and paper strips-CaCO₃ versus the number of irrigation cycles based on the test method of WO 02/049430.

FIG. 6 shows a plot of the release rate of the phosphites from Biodac® granules to the soil versus the amount of added water.

FIG. 7 shows a plot of the release rate of MAP, DAP and Fosetyl-Al from Biodac® granules to the soil versus the amount of added water.

FIG. 8 shows a plot of the release rate of the DAP and MAP from different carriers to the soil versus the amount of added water.

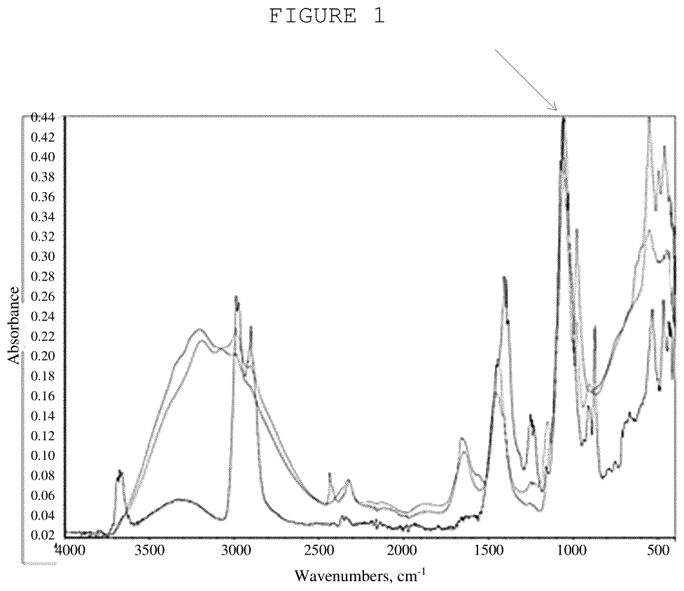

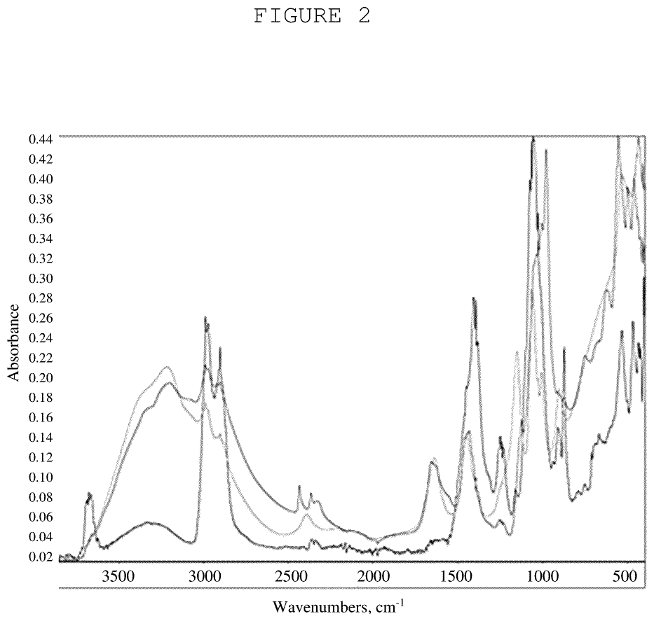

### EXAMPLES

### Materials and Methods

Potassium phosphite, ammonium hydroxide (25% solution) and phosphorous acid (98% purity assay) were purchased and used without further purification. Fosetyl-Aluminum technical grade was obtained from Sigma Aldrich. Biodac® 12/20 mesh and Biodac® 20/50 mesh were purchased from Kadant Grantek Inc. Filter papers used for the experiments were obtained from Whatman.

The present invention was demonstrated using red loam soil.

### Analytical Methods

The ion exchange chromatography (IC) for the determination of phosphite concentration was carried out using a Metrohm Compact IC Flex chromatography system.

Iodometric titration was performed using a potentiometric redox method (see, for example, Anal. Chem. 1953, 25, 8, 1272-1274: Determination of Hypophosphorous and Phosphorous Acids by R. T. Jones and E. H. Swift].

FTIR spectrums were recorded on the Agilent spectrometry instrument.

### Preparations 1 to 5

### Solutions of Phosphorous Acid and Phosphite Salts Containing the Equivalent of ˜30% of Phosphorous Acid

1) Phosphorous acid, 32%

Phosphorous acid (32.7 g; 98% purity assay) was dissolved in 67.3 g of water under stirring to obtain a clear solution (pH=0.1).

2) Monopotassium phosphite (MPP) (32% H₃PO₃)

KH₂PO₃ (47 g) was dissolved in 53 g of water under stirring to obtain a clear solution (pH=4.0-4.5).

3) Monoammonium phosphite (MAP) (32% H₃PO₃)

Phosphorous acid (32.7 g; 98% purity assay) was dissolved in 41 g of water under stirring. 26.1 g of NH₄OH solution (25%) was added slowly to react with the acid to obtain a clear solution of the MAP salt (pH=4.0-4.5)

4) Diammonium Phosphite (DAP) (32% H₃PO₃)

Phosphorous acid (32.7 g; 98% purity assay) was dissolved in 15.1 g of water under stirring. 52.2g of NH₄OH solution (25%) was added slowly to react with the acid to obtain a clear solution of the DAP salt (pH=6.0-7.0).

5) Fosetyl-Aluminum

Fosetyl-Aluminum (1 g; technical grade) was dissolved in 9 g of water under stirring to obtain a clear solution of Fosetyl-Aluminum.

### Examples 1-12

### Loading Solutions of Phosphorous Acid and Phosphite Salts onto Cellulosic Carriers

Three types of carriers were used: 1) cellulosic granules Biodac® 12/20 and 20/50; 2) paper strips; and 3) paper strips to which calcium carbonate was added.

Examples 1 to 7: Biodac® 12/20 granules (200g) were mixed uniformly with each of the phosphorous acid, MPP, MAP and DAP solutions described in preparations 1 to 4, and with some combinations of these solutions (the total weight of solution(s) added to the granules was 100 g), to obtain ACID-Biodac®, MPP-Biodac®, MAP-Biodac®, DAP-Biodac® and MPP/DAP-Biodac® granules respectively. The granules, with an active ingredient loading of about ˜10-11% looked dry, were flowable, and showed slight alkalinity when added to water at 5% by weight concentration (pH of 7.5-8.0), except for ACID-Biodac® (pH=5.4).

Example 8: Biodac® 20/50 granules (90 g) were mixed uniformly with the Fosetyl-Aluminum solution (10 g) described in preparation 5 to obtain Fosetyl-Aluminum-Biodac® granules.

Examples 9 and 10: Paper strilps (2 g) were mixed each of the MAP and DAP solutions of preparations 3 and 4, to obtain MAP-paper strips or DAP-paper strips granules respectively.

Examples 11 and 12: the carriers were paper strips, to which calcium carbonate was added. Paper strips (5 g), CaCO₃ (0.6 g) and water (9 g) were mixed uniformly. Then, either a MAP or a DAP solution of preparations 3 or 4 was added and the mass was uniformly mixed to obtain MAP-paper strips-CaCO₃ or DAP-paper strips-CaCO₃ respectively, all with an essentially dry aspect. Table 2 summarizes the compositions which were prepared.

TABLE 2

| Example | Carrier | Solution (s) added |
|---|---|---|
| 1 (invention) | Biodac (R) (200 g) | H₃PO₃ (100 g) |
| 2 (invention) | Biodac (R) (200 g) | KH₂PO₃ (100 g) |
| 3 (invention) | Biodac (R) (200 g) | (NH₄) H₂PO₃ (100 g) |
| 4 (comparative) | Biodac (R) (200 g) | (NH₄) ₂HPO₃ (100 g) |
| 5 (invention) | Biodac (R) (200 g) | KH₂PO₃ + (NH₄) ₂H₂PO₃ |
| | | (75 g + 25 g) |
| 6 (invention) | Biodac (R) (200 g) | KH₂PO₃/(NH₄) ₂H₂PO₃ |
| | | (50 g + 50 g) |
| 7 (invention) | Biodac (R) (200 g) | KH₂PO₃/(NH₄) ₂H₂PO₃ |
| | | (25 g + 75 g) |
| 8 (invention) | Biodac (R) (90 g) | Al [HP (O) (OCH₂CH₃) |
| | | (O⁻)]₃ (10 g) |
| 9 (comparative) | Paper strips (2 g) | (NH₄) H₂PO₃ (1 g) |
| 10 (comparative) | Paper strips (2 g) | (NH₄) ₂HPO₃ (1 g) |
| 11 (invention) | Paper strips (5 g)+ | (NH₄) H₂PO₃ (1 g) |
| | CaCO₃ (0.6 g) | |
| 12 (comparative) | Paper strips (5 g)+ | (NH₄) ₂HPO₃ (1 g) |
| | CaCO₃ (0.6 g) | |

### Examples 13 to 18

### Release Tests of Phosphite from Cellulosic Carriers: Evaluation by Filtration Experiments

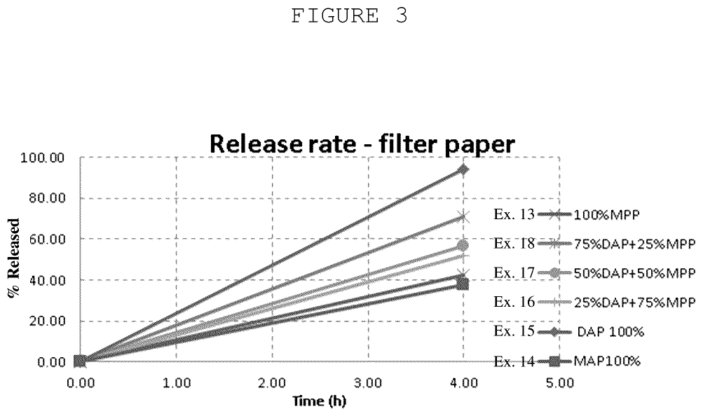

A flask fitted with a conical filter paper was used for the experiments. The granules of Examples 2 to 7 (10 g) were placed on the filter paper and were then water-soaked with 80 ml of water. The concentration of the phosphite in the filtrate was determined by iodometric titration. Release rates are shown in FIG. 3 versus time (Examples 13 to 18 correspond to the testing of the granules of Examples 2 to 7, respectively).

The results are shown in FIG. 3 indicate dissimilarity between the behavior of monovalent salts [KH₂PO₃ and (NH₄)H₂PO₃], which are released slowly, as opposed to divalent salts [(NH₄)₂HPO₃], which are released rapidly. Mixed monovalent/divalent salts loaded onto Biodac® granules show a trend of increasing release rate with the increasing proportion of the divalent salt in the blend.

### Examples 19 (Invention) and 20 to 23 (Comparative)

### Release Tests of Phosphite from Cellulosic Carriers: Evaluation by the Experimental Set-Up of WO 02/49430

In WO 02/049430, the release profile of phosphites from the coated carriers was evaluated by mixing the tested carrier (1 g) with water (2 ml) and allowing the mixture to stand for two hours. Next, the supernatant was collected, and the concentration of phosphorous acid was measured by high pressure liquid chromatography. The cycle was repeated ten times, to simulate conditions of irrigation by sprinkling. Results are reported in Table 1 on page 21 of WO 02/49430.

A similar approach was used to test the carriers of the invention. 2 g of the carriers of Examples 3 and 4 (˜0.2 g of phosphite content) were mixed with 8 ml of water. The supernatant was collected after two hours and the concentration of phosphorous acid was measured by ion chromatography (IC). The cycle was repeated ten times.

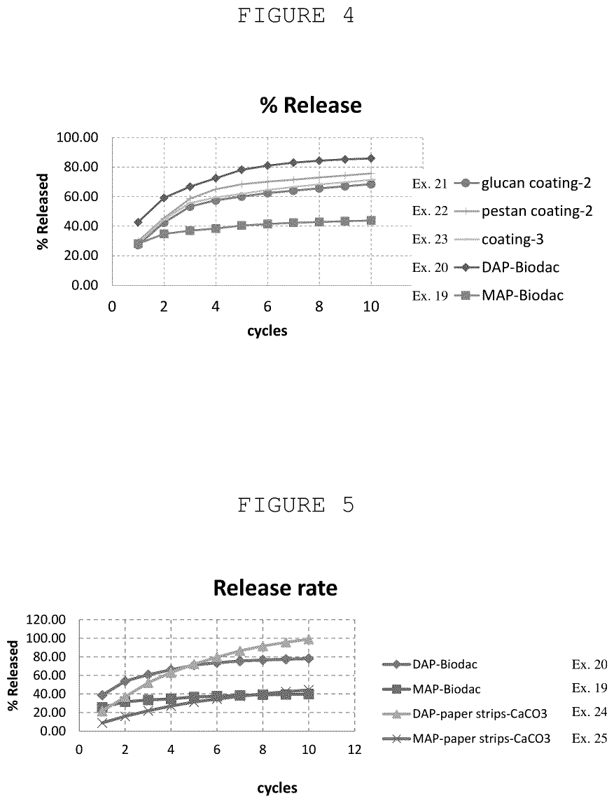

The results are presented graphically in FIG. 4, showing the cumulative percentage of phosphite released from the tested carrier versus cycle numbers. The slowest release rate was demonstrated by the carrier of the invention, MAP-Biodac®, as opposed to the DAP-Biodac®, from which the active agent was released fairly rapidly (identified as Examples 19 and 20 in FIG. 4). The coated carriers of WO 02/49430 provided higher levels of active agent compared to MAP-Biodac®, i.e., they are less effective as slow-release compositions (identified as Examples 21-23 in FIG. 4; plots for the three prior art carriers were generated based on Table 1 on page 21 of WO 02/49430).

### Examples 24 and 25

### Release Tests of Phosphite from Cellulosic Carriers: Evaluation by the Experimental Set-Up of WO 02/49430

The carriers of Examples 11 and 12, which were produced by absorbing calcium carbonate on paper strips, followed by soaking with a solution of MAP and DAP, respectively, were tested by the experimental set-up of WO 02/49430.

The results are shown in FIG. 5. To enable easy comparison, the curves corresponding to MAP-Biodac® and DAP-Biodac® are reproduced. It is seen that the monovalent salts are released in comparably slower rate from the cellulosic granular carrier Biodac® and the CaCO₃-added paper strips. The release rate demonstrated by the diammonium salt is considerably faster from both carriers.

### Examples 26 to 28 (Invention) and 29 (Comparative)

### Release Tests of Phosphite from Cellulosic Carriers: Evaluation in Soil

Each sample consists of soil (130 g) mixed with 2 g of a phosphite formulation. The formulations tested were:

ACID-Biodac® of Example 1 (corresponding to Example 26);

MPP-Biodac® of Example 2 (corresponding to Example 27);

MAP-Biodac® of Example 3 (corresponding to Example 28); and

DAP-Biodac® of Example 4 (corresponding to Example 29).

The amount of phosphite in all samples was the same (0.2 g). 0.4-liter flowerpots were filled with the soil samples. A total number of twelve flowerpots were used, equally divided into four groups, such that each group consisted of three replicates of each sample treated with the same formulation.

Overhead irrigation was applied, supplying a metered amount of water (400 mL) to cause water draining. The drained water was collected, weighed and the phosphite concentration was determined by IC.

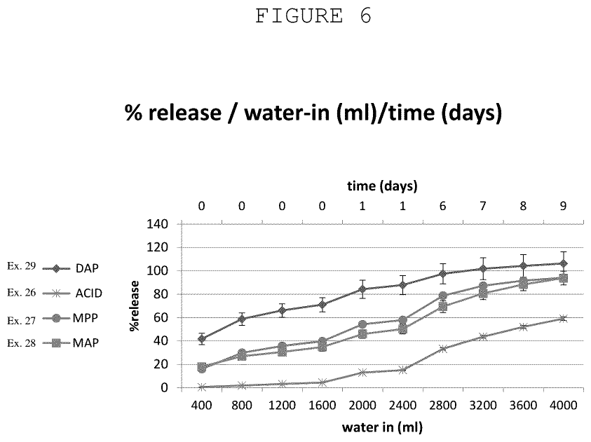

The results are shown graphically in FIG. 6. The ordinate indicates the cumulative percentage of active agent released from the granular carrier (group average). The lower abscissa is the cumulative volume of water added, and the upper abscissa is the time scale (the experiment lasted ten days; water was added four times on day zero, twice on the first day, and once during the sixth, seventh, eighth and ninth days). The results indicate that the free acid and the monovalent salts are released more slowly from the cellulosic granular carrier, compared to the divalent salt.

### Examples 30 (Comparative) and 31 (Invention)

### Release Tests of Fosetyl-Aluminum from a Cellulosic Carrier: Evaluation in Soil

The sample for Example 30 was prepared by mixing soil (130 g) with 1 g of a solution containing 10% of Fosetyl-Aluminum technical as described in Preparation 5. The sample for Example 31 was prepared by mixing 130 g of soil with 10 g of Fosetyl-Aluminum-Biodac® formulation prepared as described in Example 8.

0.4-liter flowerpots were filled with the soil samples. A total number of six flowerpots were used, equally divided into two groups, such that each group consisted of three replicates of each one of the samples treated with the same formulation.

Overhead irrigation was applied, supplying a metered amount of water (400 mL) to cause water draining. The drained water was collected, weighed and the phosphite concentrations were determined by IC.

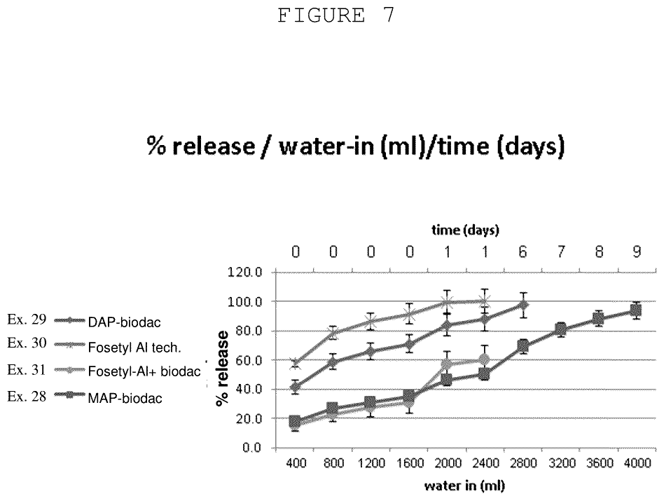

The results are shown graphically in FIG. 7. The ordinate indicates the cumulative percentage of active agent released from the samples. The lower abscissa is the cumulative volume of water added, and the upper abscissa is the time scale. The results indicate that the cellulosic carrier can be used to slow down the release rate of phosphite from Fosetyl-Aluminum (see the curves corresponding to Examples 30 and 31 in FIG. 7). Monovalent phosphite salts (MAP, which contains the (H₂FO₃)⁻ anion, and Fosetyl-Aluminum, which contains the organic phosphite [HP(O)(OCH₂CH₃)(O⁻)] anion), behave in a similar manner when absorbed into the cellulosic carrier, showing a relatively slow release rate of the phosphite.

### Examples 32-33 and 35 (Comparative) and 34 (Invention)

### Release Tests of Phosphite from Cellulosic Carriers: Evaluation in Soil

Soil samples were prepared. Each sample consists of soil (130 g) mixed with 2-16 g of a phosphite formulation in such a way that the final concentration of phosphorous acid will be the same in all samples. The formulations tested were:

MAP-paper strips of Example 9 (corresponding to Example 32);

DAP-paper strips of Example 10 (corresponding to Example 33);

MAP-paper strips-CaCO₃ of Example 11 (corresponding to Example 34); and

DAP-paper strips-CaCO₃ of Example 12 (corresponding to Example 35).

The amount of the formulation was adjusted to provide a constant quantity of phosphite (0.2 g) in each sample.

0.4-liter flowerpots were filled with the soil samples. A total number of twelve flowerpots were used, equally divided into four groups, such that each group consisted of three replicates of each sample treated with the same formulation.

Overhead irrigation was applied, supplying a metered amount of water (400 mL) to cause water excess draining. The drained water was collected, weighed and the phosphite concentrations were measured by IC.

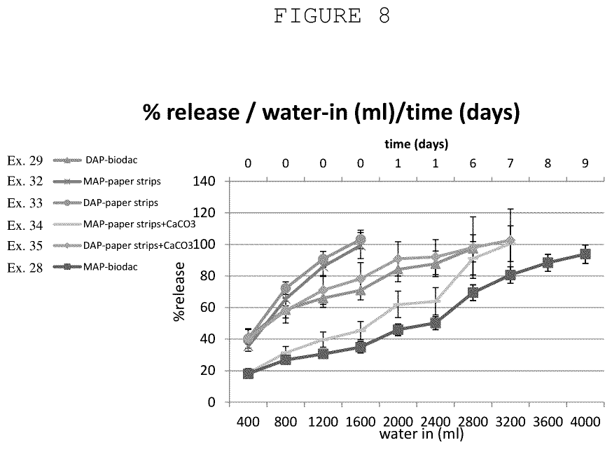

The results are shown graphically in FIG. 8. The ordinate indicates the cumulative percentage of active ingredient released from the granular carrier (group average). The lower abscissa is the cumulative volume of water added, and the upper abscissa is the time scale (the experiment lasted ten days; water was added four times on day zero, twice on the first day, and once on the sixth, seventh, eighth and ninth days). The results attest to the role of calcium source in suppressing the release of phosphite and show the same trend observed with the Biodac® carrier: a monovalent salt is released more slowly from the cellulosic carrier compared to the divalent salt.

### Examples 36-40

### Control of Pink Rot in Potato Using Mono-Ammonium Phosphite Released from a Cellulosic Carrier: a Field Study

The goal of the study was to evaluate the effect achieved by releasing MAP from the cellulosic carrier on Pink Rot in potatoes (a disease caused by Phytophthora Erythroseptica, a soil-borne pathogen).

For the study, potato for the growth of baby tubers of the Mary Spears variety was used. The potato was grown in sandy soil, in a field known to be infested with the pathogen. The experimental design consisted of four different treatments and one control group. A total of twenty sowing strips, each 15 m long, were divided equally and randomly between the four treatment and control groups (that is, four repetitions per treatment/control). After sowing without covering, the tested material was spread or sprayed on the seeds and then mechanical covering was performed. The treatments include the application of 2.5 and 5 Kg per 1000 m² of ammonium mono-phosphite in the form of the 10% granular preparation of Example 3 (Examples 38, 39) and the application of suspension concentrate (SC) formulation of fluazinam (60 g/liter)/phosphorous acid (420 g/liter) at a rate of 2.5 and 5 liter per 1000 m² (Examples 36, 37). Water was supplied by sprinkling and drip irrigation systems.

At the end of the 60 days growth period, tubers were counted in each plot (strip) and crop (in kg) was determined for each plot (strip).

The results (averaged over the repetitions) are shown in Table 3. It is worth noting that plant health assessments were performed and no phytotoxicity was observed in any of the treatments. Also, the tubers were examined in a laboratory to determine the level of residual phosphite, and no phosphite was found.

TABLE 3

| | | | | The average |
|---|---|---|---|---|
| | | | Crop, | number of |
| Example | Treatment | Dosage | Kg | tubers |
| 36 | Fluazinam + PA | 2.5 L/1000 m² | 6.98 | 176.3 |
| (comparative) | | | | |
| 37 | Fluazinam + PA | 5.0 L/1000 m² | 6.64 | 133.8 |
| (comparative) | | | | |
| 38 (invention) | MAP-Biodac ® | 2.5 kg/1000 m² | 7.50 | 190.3 |
| 39 (invention) | MAP-Biodac ® | 5.0 kg/1000 m² | 7.22 | 174.0 |
| 40 | Control | — | 6.37 | 157.5 |

The treatments with MAP-Biodac® lowered the disease severity index, both in the treatment with 2.5 kg/1000 m² and with 5.0 kg/1000 m² of MAP-Biodac®. An increase of the crop was observed. The effect is also seen in the number of tubers.

### Examples 41-43

### Effect of Mono-Ammonium Phosphite Released from a Cellulosic Carrier on Potato: a Field Trial

A field trial was conducted to determine the effect achieved by releasing MAP from the cellulosic carrier on plant vigor and yield in potato. The plots were arranged in a randomized complete block design with six replications. Each plot consisted of two 25-foot-long and 3-foot-wide rows. Soil applications were made into opened furrows, followed by planting of potato ‘Atlantics’ seed pieces with 8-in in-row plant spacing on 36-in row spacing. Fertilizer (10:10:10 in N:P:K) was applied at 350 lb/A. The soil contained 1.3% organic matter, and the pH was 5.6. Chemicals were applied in the soil at planting on 20 Mar. 2023; monthly precipitations were 1.45, 6.95, 2.09, and 2.23.7 inches, and monthly high temperatures were 86, 87, 85, and 92° F. in March, April, May, and June, respectively. Plant emergence was counted on 21 Apr. Coragen at 12.0 oz/A was used for controlling of insects.

The treatments and the results are tabulated in Table 4. In addition to nontreated control group (Example 41), a comparative treatment (Example 42) consisted of conventional application by foliar spray of a mixture of commercial fungicides against potato blight. The commercial fungicides were applied in an alternate manner according to their acceptable application rates. The treatment of the invention consisted of application at planting of MAP-Biodac®, adjacent to the planted seed pieces, at application rate of 600Z WT/1000 row-FT, and subsequently, at an appropriate time, application by foliar spray of a pair of commercial fungicides against potato blight.

Each treatment was evaluated by determining the marketable yield: tubers with a diameter equal to or greater than 1.5 inches were counted as marketable yield. Data were analyzed using the ARM (Gylling Data Management). The details and the results are tabulated in Table 4.

TABLE 4

| | | | Marketable |
|---|---|---|---|
| Example | Treatment | application | yield* (lb) |
| 41 (reference) | Non-treated control | | 16.0b |
| 42 (comparative) | Fungicide X | Foliar spray | 17.9b |
| | Fungicide Y | Foliar spray | |
| 43 (invention) | MAP-Biodac ®, | In-furrow | 23.5a |
| | 60 OZ WT/1000 row-FT | Foliar spray | |
| | Fungicide X | Foliar spray | |
| | Fungicide Y | | |

*a, b: statistical significance

A significant increase in plant vigor was observed in the MAP-Biodac® treatment. In-furrow MAP-Biodac® at planting at application rate of 600Z WT/1000 row-FT (Example 43) shows a significant improvement in yield compared to the grower standard (Example 42) and non-treated control (Example 41). No phytotoxicity was observed between treatments.

1. An agrochemical composition comprising:
an absorbent cellulosic carrier with one or more metal compound(s) incorporated into the carrier, and an active agent selected from the group consisting of phosphorous acid and phosphite salts that contain the monovalent anion [HP(O)(OX)(O⁻)], where X is H or CH₂CH₃.

2. An agrochemical composition according to claim 1, wherein the absorbent cellulosic carrier is in the form of granules.

3. An agrochemical composition according to claim 1, wherein the absorbent cellulosic carrier in the form of shredded paper selected from the group consisting of filter paper, blotting paper, chromatography paper and cellulose pulp sheets, to which was added one or more basic metal compounds, at a concentration of not less than 1% by weight.

4. An agrochemical composition according to claim 1, wherein the metal compound is a basic metal compound selected from the group consisting of an alkaline earth metal oxide, carbonate or hydroxide.

5. An agrochemical composition according to claim 1, wherein the phosphite salt is selected from the group consisting of Mⁿ⁺(H₂PO₃⁻)ₙ, where n is 1, and M is a monovalent counter cation.

6. An agrochemical composition according to claim 5, wherein the phosphite salt is monoammonium or monopotassium phosphite.

7. An agrochemical composition according to claim 1, wherein the phosphite salt is Fosetyl-Aluminum Al[HP(O)(OCH₂CH₃)(O⁻)]₃.

8. An agrochemical composition according to claim 1, further comprising a salt of phosphorous acid which contains the divalent anion (HPO₃)²⁻.

9. An agrochemical composition according to claim 8, wherein the salt is the diammonium or dipotassium salt of phosphorous acid.

10. An agrochemical composition according to claim 1, which is a fungicidal composition, a nematocidal composition or a fertilizer composition.

11. A process for the preparation of a controlled-release agrochemical composition, comprising impregnating an absorbent cellulosic carrier with an aqueous solution of an active agent selected from the group consisting of phosphorous acid and water-soluble phosphite salts that contain the monovalent anion [HP(O)(OX)(O⁻)], where X is H or CH₂CH₃;
and optionally with an aqueous solution of a divalent salt of phosphorous acid.

12. A method of supplying phosphorous acid or a monovalent phosphite salt to a plant, optionally in admixture with a divalent salt of the acid, the method comprises applying the composition of claim 1 to a soil or growth medium.

13. A method according to claim 12, which is a method of protecting a plant against a fungal disease or a nematode attack.

14. A method comprising application in-furrow of the composition of claim 1 at the time of planting of a plant selected from the group consisting of Solanaceae, Brassicaceae/Cruciferae and Cucurbitales.

15. A method according to claim 14, further comprising application of one or more organic fungicides to the plant or the growth medium.

16. A method according to claim 15, wherein the plant is potato and the organic fungicides are applied to protect the potato from late blight and/or early blight.

17. A method according to claim 15, wherein the one or more organic fungicides are applied by foliar spray.

18. A method according to claim 17, wherein the composition applied in-furrow comprises absorbent cellulosic carrier in the form of granules, wherein the granules contain monoammonium phosphite as the active agent.
